(19) United States
(12) Patent Application Publication
(10) Pub. No.: US 2024/0369292 A1
(43) Pub. Date: Nov. 7, 2024

(54) MEDICINE STORAGE CABINET BASED ON ARTIFICIAL INTELLIGENCE

(71) Applicant: Osung System Co., Ltd., Bucheon-si (KR)

(72) Inventor: Tae-seung SHIN, Bucheon-si (KR)

(21) Appl. No.: 18/311,151

(22) Filed: May 2, 2023

(51) Int. Cl. A47B 67/02; F25D 29/00

(52) U.S. Cl. CPC A47B 67/02; F25D 29/008; F25D 2600/02

(57) ABSTRACT

The disclosure relates to an artificial intelligence (AI)-based medicine storage cabinet capable of reminding a user of a medication time. More specifically, the AI-based medicine storage cabinet may include a main body having a door formed on an exterior thereof to be opened and closed, and storing a medicine therein, a controller operably provided in the main body to alert a user of a medication time according to a set time, and a refrigerator adjusting an internal temperature of the main body under the control of the controller. The main body may include a first space and a second space independent of each other by a first partition wall, and the refrigerator may individually control internal temperatures of the first space and the second space by a set algorithm of the controller.

### BACKGROUND

### 1. Field

The disclosure relates to an artificial intelligence (AI)-based medicine storage cabinet capable of reminding a user of a medication time, which may prevent misuse and abuse of medicines, block children from easily withdrawing stored medicines, and prevent the deterioration of stored medicines.

### 2. Description of Related Art

Along with the recent change of disease patterns to chronic diseases caused by an increase in the elderly population and the influence of western food culture, medication and medicine management have become important factors in healthcare.

A prior art document, Korean Patent Publication No. 2013-143152 discloses a medication reminder alarm system that alerts a patient of a medication time by an alarm setting, and allows alarm sounds to stop only when a box is opened, thereby encouraging the patient to take medicines at all times, and that also has an electronic clock installed therein to function as a clock.

However, the medication reminder alarm system is not equipped with a locking function to prevent medicine misuse and abuse and toxic drug-incurring accidents.

Moreover, another problem with the prior art lies in that when there are temperature-sensitive medicines among different types of stored medicines, they may be deteriorated by the temperature inside a storage room before their expiration dates.

### SUMMARY

To solve the above-described problems of the prior art, the disclosure provides a medicine storage cabinet which easily reminds a user of a medication time by sounding alarm at a specified time, and includes a locking device for preventing medicine misuse and accidents caused by toxic drugs.

The disclosure is also intended to prevent deterioration of temperature-sensitive medicines before expiration dates by controlling temperature inside a storage room where the medicines are stored.

Additional aspects will be set forth in part in the description which follows and, in part, will be apparent from the description, or may be learned by practice of the presented embodiments of the disclosure.

According to the disclosure, a medicine storage cabinet based on artificial intelligence may include a main body (100) having a door (130) formed on an exterior thereof to be opened and closed, and storing a medicine therein, a controller (200) operably provided in the main body (100) to alert a user of a medication time according to a set time, and a refrigerator (300) adjusting an internal temperature of the main body (100) under the control of the controller (200). The main body (100) may include a first space (133) and a second space (135) independent of each other by a first partition wall (110), and the refrigerator (300) may individually control internal temperatures of the first space (133) and the second space (135) by a set algorithm of the controller (200).

Further, a medicine sensitive to a temperature change in medicinal effect may be stored in the first space (133), and a medicine insensitive to a temperature change in medicinal effect may be stored in the second space (135).

Further, at least one of the first space (133) or the second space (135) may be partitioned by a second partition wall (120) extending from the first partition wall (110), and a storage (140) slidable to be withdrawn to an outside may be installed in a partitioned space to accommodate a medicine.

Further, the controller (200) may include a main control panel (210) controlling the refrigerator (300), and a sub control panel (220) controlling the door (130) to a locked state and an unlocked state to open and close the door (130). The main control panel (210) may be formed on the main body (100) to communicate with a user terminal (400) over a short-range wireless communication network, and the sub control panel (220) may be formed on the first partition wall (110) to individually control a pair of doors (130).

Further, the main control panel (210) may further include an emergency switch (217) provided in the main body (100).

According to the disclosure, as a pair of doors opening and closing a first space and a second space partitioned inside a main body may be opened and closed by touches on a lock display and an unlock display provided on a sub control channel, medicine misuse and easy access to the doors from children may be prevented, compared to the prior art.

Further, refrigerators capable of controlling the temperatures of the first space and the second space, respectively may prevent easy deterioration of stored medicines, compared to the prior art.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating an artificial intelligence (AI)-based medicine storage cabinet according to the disclosure;

FIG. 2 is a diagram illustrating a state in which doors of FIG. 1 are opened;

FIG. 3 is a diagram illustrating the inside of a main body with the doors of FIG. 1 removed therefrom;

FIG. 4 is a conceptual diagram illustrating a controller for the AI-based medicine storage cabinet according to disclosure; and

FIG. 5 is a block diagram illustrating the configuration of the controller of FIG. 4.

### DETAILED DESCRIPTION

Various embodiments will be described below in detail with reference to the accompanying drawings. The embodiments described in this specification may be modified in various manners. Certain embodiments may be depicted in the drawings and described in detail in the detailed description. However, specific embodiments illustrated in the accompanying drawings are only intended to facilitate understanding of various embodiments. Therefore, the technical idea is not limited by the specific embodiments illustrated in the accompanying drawings, and it should be understood as encompassing all equivalents or substitutes within the spirit and scope of the disclosure.

With reference to the attached drawings, a detailed description will be given of an artificial intelligence (AI)-based medicine storage cabinet (hereinafter, simply referred to as a ‘medicine storage cabinet’) according to the disclosure.

Prior to the description, it is to be noted that although a medicine storage cabinet 1 according to the disclosure is described below as storing medicines such as potions, pills, ointments, and body-attachable anti-inflammatory analgesics, this is only an embodiment, and cosmetics with a high possibility of deterioration due to temperature changes may also be stored if necessary.

In addition, a user terminal 400 and a guardian terminal 500 described later refer to electronic devices capable of short-range wireless communication with a controller 200, such as a smartphone or a tablet personal computer (PC).

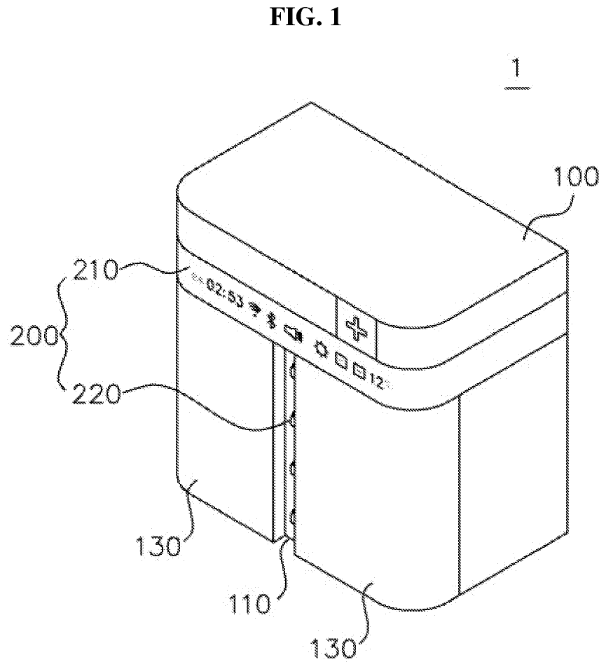

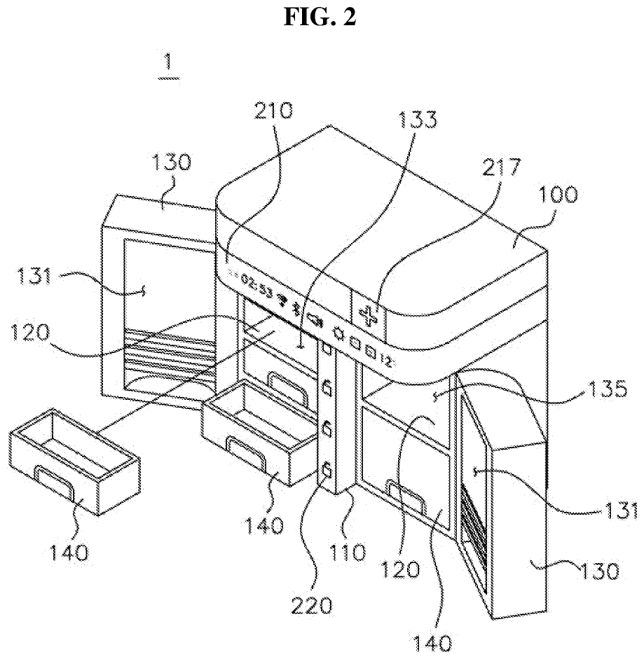

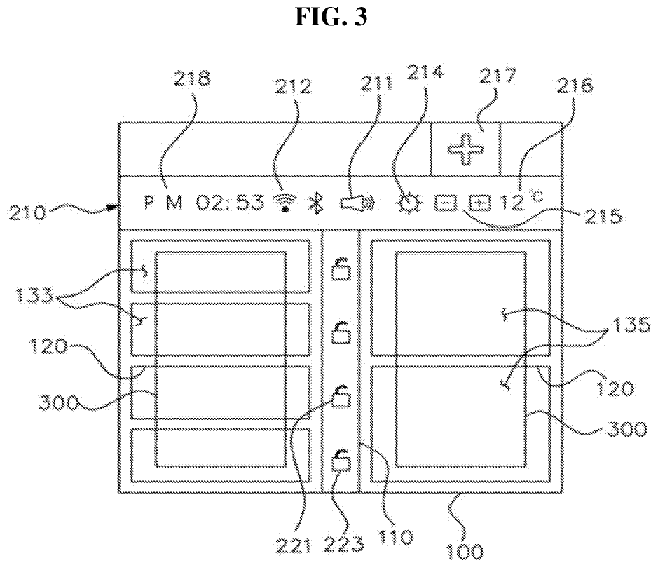

As illustrated in FIGS. 1 to 3, the medicine storage cabinet 1 according to the disclosure largely includes a main body 100, the controller 200, and a refrigerator 300.

Specifically, the main body 100 is provided with the controller 200 and the refrigerator 300, which will be described later, and includes a first partition wall 110, a second partition wall 110, a door 130, and a storage 140, as components for accommodating medicines available to a user.

As illustrated, for example, the first partition wall 110 between a pair of doors 130 forms a first space 133 and a second space 135 independent of each other by partitioning the inside of the main body 100 such that the first partition wall 110 has a length in a vertical direction.

For example, medicines sensitive to temperature changes in medicinal effect, such as antibiotics, are stored in the first space 133, and medicines insensitive to temperature changes in medicinal effect, such as pills or anti-inflammatory analgesics, are stored in the second space 135.

Obviously, besides medicines, medical aids that are not affected by temperature changes, such as bandages or bands, may also be stored in the second space 135.

At least one of the above-described first space 133 or second space 135 may be further divided by at least one second partition wall 120 connected to the first partition wall 110.

Therefore, a plurality of medicines of different sizes or types may be accommodated in the single main body 100.

At least one storage 140 that may be withdrawn to the outside may be further provided in the above-described first space 133 and second space 135. The storage 140 is molded using a transparent synthetic resin material, and slides into and out of the main body 100 under the guidance of the first partition wall 110 and the second partition wall 120, when the door 130 is opened.

The use of the storage 140 enables the user to classify and store medicines by type or by day of the week.

Further, a pair of doors 130 are rotatably installed on the front surface of the main body 100 by hinges or the like, as illustrated. The rotation of the doors 130 enables opening and closing of the first space 133 and the second space 135.

Preferably, the space for accommodating medicines is allowed to be extended by further forming a storage space 131 on the inner surface of each door 130, separately from the above-described first space 133 and second space 135.

A fence may be further formed on the door 130 in which the storage space 131 is formed, to prevent medicines accommodated in the storage space 131 from escaping due to the rotation of the door 130.

For example, the door 130 may be ‘locked’ to or ‘unlocked’ from the main body 100 by a locking means (not shown). For this purpose, the locking means is a solenoid installed on the first partition wall 110, for locking or unlocking.

The solenoid performs ‘locking’ and ‘unlocking’ through manipulation of a sub control panel 220 provided on the first partition wall 110 to be exposed to the outside.

A temperature sensor (not shown) is individually installed in each of the first space 133 and the second space 135 in the disclosure. The temperature of each space is measured by the later-described refrigerator 300 and then transmitted to the controller 200 so that the temperature may be identified on a temperature display 216.

In addition, as the temperature sensor has a bimetal structure capable of ON/OFF switching between the refrigerator 300 and the controller 200, an automatic control scheme may be selected, in which the refrigerator 300 is turned off at a set temperature or higher and turned on below the set temperature.

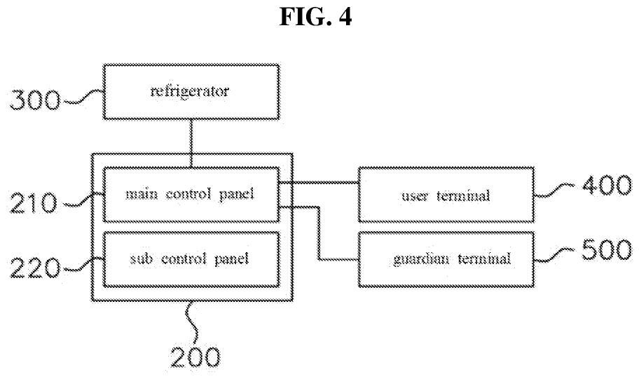

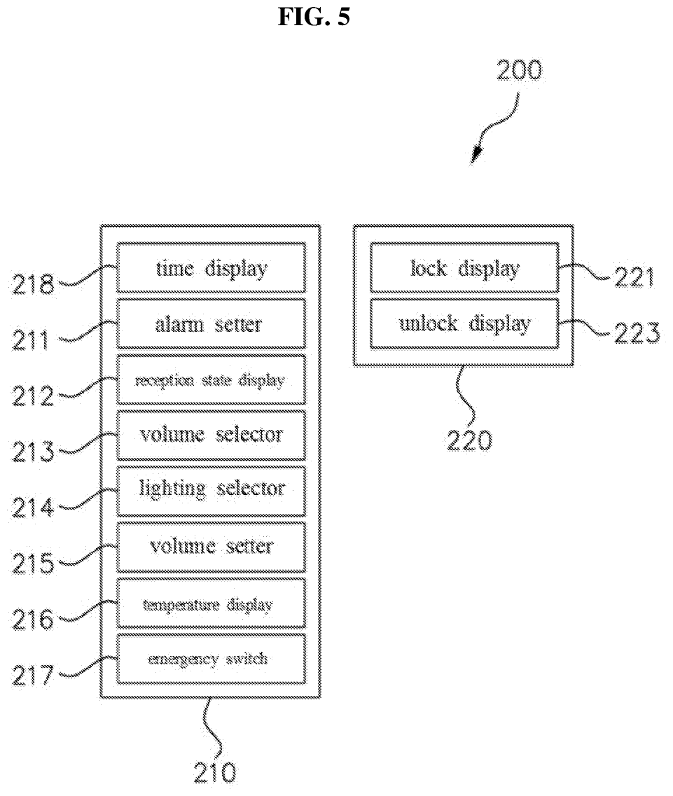

Further, referring to FIGS. 4 and 5, the controller 200 includes a main control panel 210 and the sub control panel 220 as components for preventing the deterioration of medicines by controlling temperature inside the first space 133 and the second space 135, and controlling opening and closing of the doors 130.

For example, the main control panel 210 may control at least one of setting of an alarm time for the medicine storage cabinet 1 of the disclosure, a communication state with the user terminal 400, or illumination and temperature of each of the first space 133 and the second space 135.

For each control described above, the main control panel 210 includes at least one of a time display 218, an alarm setter 211, a reception state display 212, a volume selector 213, a lighting selector 214, a volume setter 215, or the temperature display 216.

The time display 218 displays a current date and time in real time.

The alarm setter 211 is operated by a user's touch, and allows the user to set an alarm time at which a medicine is to be taken by displaying an intended set time on the time display 218 after the touch.

Preferably, the alarm setter 211 enables setting of a plurality of alarms to be sounded at different times, for example, in the morning, afternoon, and evening.

The reception state display 212 indicates a connection state with the user terminal 400. As illustrated, the connection state may be displayed by a symbol of Bluetooth or wireless fidelity (Wi-Fi), which is a short-range wireless communication network.

For example, once the user terminal 400 and a communication network are connected to each other, the Bluetooth or Wi-Fi symbol of the reception state display 212 is turned on so that the user may identify the connection state.

When a sound signal is output through a speaker (not shown) at an alarm time set by the above-described alarm setter 211, the volume selector 213 enables adjustment of the intensity of the output sound by the volume setter 215 displaying ‘+’ and ‘−’.

For example, when the intensity of sound is to be adjusted, the volume selector 213 is first selected by a touch, and then the intensity of the sound is increased or decreased by one or more touches on ‘+’ or ‘−’ of the volume setter 215.

The lighting selector 214 is for adjusting the intensity of lamps (not shown) individually provided in the first space 133 and the second space 135 by the volume setter 215, and the intensity is set in the same manner as the setting of the volume selector 213.

The temperature display 216 displays the temperatures of the first space 133 and the second space 135, which have been adjusted by the later-described refrigerator 300, in real time.

Preferably, the temperatures of the first space 133 and the second space 135 are individually displayed on the temperature display 216.

Information set through the main control panel 210 in the disclosure, particularly an alarm setting may be identified and operated through an application installed in the user terminal 400 connected through a wireless communication network.

Accordingly, even though the user far from the medicine storage cabinet 1 takes rest (e.g., sleeps), an alarm is sounded through the user terminal 400 to alert the user to take medicine at a predetermined time.

Furthermore, the main control panel 210 in the disclosure may further include an emergency switch 217 formed on the main body 100, and the emergency switch 217 may transmit an emergency signal to an emergency rescue center, a hospital, and the guardian terminal 500 of a guardian other than a user, for emergency treatment.

In addition, as illustrated, the sub control panel 220 may be displayed in a touch switch method on an outer surface of the first partition wall 110 so that the pair of doors 130 may be ‘locked’ and ‘unlocked’.

To this end, a lock display 221 and an unlock display 223 may form a pair in the sub control panel 220 so that each door 130 may be individually controlled.

Although the lock display 221 and the unlock display 223 may open and close the doors 130 in a one-touch manner, the doors 130 may also be ‘locked’ and ‘unlocked’ by entering a password such as numbers or characters through an input unit (not shown) to prevent a child from easily opening and closing the doors 130.

The refrigerator 300 may maintain each of the first space 133 and the second space 135 in a refrigerated state. For this purpose, a plurality of refrigerators 300 may be installed in the main body 100 to control the temperatures of the first space 133 and the second space 135, respectively.

Although not shown in the drawings, the refrigerator 300 may include a compressor, a condenser, an expansion valve, an evaporator, and so on.

The above components may maintain the refrigerated state by operating to circulate a refrigerant, and thus medicines sensitive to temperature changes may be kept usable.

Compared to the prior art, the medicine storage cabinet 1 according to the disclosure may prevent medicine misuse and easy access to the doors from children by allowing a pair of doors 130, which open and close the first space 133 and the second space 135 partitioned inside the main body 100, to be opened and closed by touches on the lock display 221 and the unlock display 223 provided on the sub control channel 220.

Further, compared to the prior art, the refrigerators 300 capable of controlling the temperatures of the first space 133 and the second space 135, respectively may prevent easy deterioration of stored medicines.

While the disclosure has been described by specific details such as specific components, and limited embodiments and drawings, these are provided only to help the comprehensive understanding of the disclosure, and the disclosure is not limited to the above embodiments. Those skilled in the art can make various modifications and variations from these descriptions.

Therefore, the spirit of the disclosure should not be limited to the described embodiments, and all of the appended claims and their equivalents or equivalent modifications fall within the scope of the disclosure.

### DESCRIPTION OF REFERENCE NUMERALS

| | |
|---|---|
| 1: AI-based medicine storage cabinet | |
| according to the disclosure | |
| 100: body | |
| 110: first partition wall | 120: second partition wall |
| 130: door | 131: storage space |
| 133: first space | 135: second space |
| 140: storage | |
| 200: controller | |
| 210: main control panel | 211: alarm setter |
| 212: reception state display | 213: volume selector |
| 214: lighting selector | 215: volume setter |
| 216: temperature display | 217: emergency switch |
| 218: time display | 220: sub control panel |
| 221: lock display | 223: unlock display |
| 300: refrigerator | |
| 400: user terminal | |
| 500: guardian terminal | |

What is claimed is:

1. A medicine storage cabinet based on artificial intelligence, comprising:
a main body (100) having a door (130) formed on an exterior thereof to be opened and closed, and storing a medicine therein;
a controller (200) operably provided in the main body (100) to alert a user of a medication time according to a set time; and
a refrigerator (300) adjusting an internal temperature of the main body (100) under the control of the controller (200),
wherein the main body (100) includes a first space (133) and a second space (135) independent of each other by a first partition wall (110), and the refrigerator (300) individually controls internal temperatures of the first space (133) and the second space (135) by a set algorithm of the controller (200).

2. The medicine storage cabinet according to claim 1, wherein a medicine sensitive to a temperature change in medicinal effect is stored in the first space (133), and a medicine insensitive to a temperature change in medicinal effect is stored in the second space (135).

3. The medicine storage cabinet according to claim 1, wherein at least one of the first space (133) or the second space (135) is partitioned by a second partition wall (120) extending from the first partition wall (110), and a storage (140) slidable to be withdrawn to an outside is installed in a partitioned space to accommodate a medicine.

4. The medicine storage cabinet according to claim 1, wherein the controller (200) includes:
a main control panel (210) controlling the refrigerator (300); and
a sub control panel (220) controlling the door (130) to a locked state and an unlocked state to open and close the door (130),
wherein the main control panel (210) is formed on the main body (100) to communicate with a user terminal (400) over a short-range wireless communication network, and
wherein the sub control panel (220) is formed on the first partition wall (110) to individually control a pair of doors (130).

5. The medicine storage cabinet according to claim 4, wherein the main control panel (210) further includes an emergency switch (217) provided in the main body (100).
